(19) United States
(12) Patent Application Publication
(10) Pub. No.: US 2018/0362707 A1
(43) Pub. Date: Dec. 20, 2018

(54) AROMATIC THERMOPLASTIC COPOLYESTERS COMPRISING 1,4:3,6-DIANHYDROHEXITOL AND VARIOUS CYCLIC DIOLS

(71) Applicant: ROQUETTE FRERES, Lestrem (FR)

(72) Inventors: Nicolas JACQUEL, Lambersart (FR); Gabriel DEGAND, Lambres (FR); René SAINT-LOUP, Lomme (FR)

(73) Assignee: ROQUETTE FRERES, Lestrem (FR)

(21) Appl. No.: 15/781,387

(22) PCT Filed: Dec. 2, 2016
(86) PCT No.: PCT/FR2016/053180

§ 371 Date: Jun. 4, 2018

(30) Foreign Application Priority Data
Dec. 2, 2015 (FR) 15 61753
Feb. 15, 2016 (FR) 16 51205

(51) Int. Cl. C08G 63/672; C08G 63/80; C08G 63/85; G02B 1/04

(52) U.S. Cl. CPC C08G 63/672; C08G 63/80; B32B 27/08; G02B 1/04; C08G 2250/00; C08G 63/85

(57) ABSTRACT

A thermoplastic polyester including: at least one 1,4:3,6-dianhydrohexitol unit (A); at least one cyclic diol unit (B) other than cyclohexanedimethanol units and 1,4:3,6-dianhydrohexitol units (A); and at least one aromatic carboxylic diacid unit (C), the polyester being free from ethylene glycol units. It also relates to the production method and use of same.

### FIELD OF THE INVENTION

The present invention relates to a thermoplastic polyester devoid of ethylene glycol units and having a high degree of incorporation of 1,4:3,6-dianhydrohexitol units. Another subject of the invention is a process for producing said polyester and the use of this polyester for producing various optical articles.

### TECHNOLOGICAL BACKGROUND OF THE INVENTION

Optical glass and transparent optical resins are used for the manufacture of optical lenses in various optical devices, such as for example cameras, movie cameras, telescopes, magnifying glasses, binoculars or projectors. Transparent optical resins also have an application in the form of optical film, for example for screens of electronic devices.

Optical glass has excellent properties of heat resistance, transparency, dimensional stability and chemical resistance. However, its cost price is high and it cannot, or can only with difficulty, be transformed by molding. Unlike optical glass, a lens manufactured from a transparent optical resin, in particular a transparent thermoplastic resin, has the advantage that it can be easily mass-produced by injection molding.

Examples of transparent optical resins comprise especially polycarbonates and poly(methyl methacrylate) (PMMA). However, these resins have several drawbacks. The high viscosity of polycarbonates poses problems in terms of the forming thereof. Moreover, polycarbonates have limited resistance to UV radiation. As regards poly(methyl methacrylate), it has limits in optical applications subjected to high temperatures, such as, for example, projector lenses or the screens of electronic devices, due to its low heat resistance.

Thus, there currently remains a need to find novel transparent resins having advantageous optical properties that may readily be formed and having high impact strength and also heat resistance.

It is to the Applicant's credit to have found that this objective can be achieved with thermoplastic polyesters comprising 1,4:3,6-dianhydrohexitol units and units of a cyclic diol other than cyclohexanedimethanol units and the 1,4:3,6-dianhydrohexitol units.

### SUMMARY OF THE INVENTION

A subject of the invention is thus a thermoplastic polyester comprising:
at least one 1,4:3,6-dianhydrohexitol unit (A);
at least one cyclic diol unit (B) other than cyclohexanedimethanol units and the 1,4:3,6-dianhydrohexitol units (A);
at least one aromatic dicarboxylic acid unit (C);
   said polyester being devoid of ethylene glycol units.

This polymer may especially be obtained by a particular production process, especially comprising a step of introducing, into a reactor, monomers comprising at least one 1,4:3,6-dianhydrohexitol (A), at least one cyclic diol (B) other than cyclohexanedimethanol and the 1,4:3,6-dianhydrohexitols (A) and at least one aromatic dicarboxylic acid (C), said monomers being devoid of ethylene glycol.

This process comprises a step of polymerization, in the presence of a catalytic system and at a high temperature, of said monomers to form the polyester, said step consisting of:
a first stage of oligomerization, during which the reaction medium is firstly stirred under inert atmosphere at a temperature ranging from 150 to 250° C., advantageously from 170 to 240° C., more advantageously from 180 to 235° C., then brought to a temperature ranging from 230 to 300° C., advantageously ranging from 240 to 290° C., more advantageously from 245 to 270° C.;
a second stage of condensation of the oligomers, during which the oligomers formed are stirred under vacuum at a temperature ranging from 240 to 320° C. so as to form the polyester, advantageously from 275 to 310° C., more advantageously from 289 to 310° C.; and a step of recovering the polyester.

The Applicant has observed, contrary to all expectations, that by not using ethylene glycol as diol monomer, it is possible to obtain novel thermoplastic polyesters having a high glass transition temperature. This may be explained by the fact that the reaction kinetics of ethylene glycol are much faster than those of 1,4:3,6-dianhydrohexitol, which greatly limits the integration of the latter into the polyester. The polyesters resulting therefrom thus have a low degree of integration of 1,4:3,6-dianhydrohexitol and consequently a relatively low glass transition temperature.

By virtue of the absence of ethylene glycol units, the polyester according to the invention has a high glass transition temperature and may be used in numerous tools for transforming plastic materials, and especially be readily transformed by molding, especially injection molding. It also has advantageous optical properties, making it possible to manufacture optical lenses having high refractive indices and a high Abbe number (variation in the refractive index with the wavelength) relative to customary polyesters. Its high glass transition temperature moreover makes it particularly well-suited for applications in the field of optics subjected to high temperatures.

Moreover, the polyesters according to the invention have advantageous optical properties, especially in terms of their transmittance, refractive index and Abbe number. Indeed, they are characterized by a high transparency and a high refractive index and a higher Abbe number than customary polyesters.

### DETAILED DESCRIPTION OF THE INVENTION

The polymer which is a subject of the invention is a thermoplastic polyester comprising:
at least one 1,4:3,6-dianhydrohexitol unit (A);
at least one cyclic diol unit (B) other than cyclohexanedimethanol units and the 1,4:3,6-dianhydrohexitol units (A);
at least one aromatic dicarboxylic acid unit (C);
   said polyester being devoid of ethylene glycol units.

As explained above, the polyester according to the invention has a high glass transition temperature. Advantageously, it has a glass transition temperature of at least 95° C., preferably of at least 100° C., more preferentially of at least 110° C. and more preferentially still of at least 120° C. In a particular embodiment, the polyester according to the invention has a glass transition temperature ranging from 95° C. to 155° C., preferably from 100° C. to 150° C., more preferentially from 110° C. to 147° C., more preferentially still from 120° C. to 145° C.

The glass transition temperature is measured by conventional methods, especially using differential scanning calorimetry (DSC) using a heating rate of 10° C./min. The experimental protocol is described in detail in the example section below.

The polyester according to the invention advantageously has a transmittance of greater than 88%, preferably of greater than 90%.

Advantageously, the polyester according to the invention has a haze of less than 2%, preferably of less than 1%.

The haze and the transmittance of the sample are measured according to the methods ASTM D1003 and ASTM D1003-95 on an injected part made of polyester according to the invention.

The refractive index of the polyester according to the invention is preferably greater than 1.50, more preferentially greater than 1.55. It may be measured on a thick injected part (for example 3 mm thick). The refractive index is then measured at 589 nm (sodium D line).

The Abbe number of the polyester according to the invention is preferably greater than 30, more preferentially greater than 50.

The Abbe number is calculated according to the formula below from three measurements of refractive index taken at 589 nm (nD: sodium D line), 486 nm (nF: hydrogen F line) and 656 nm (nC: hydrogen C line).

$$V = \frac{{n}_{D} - 1}{{n}_{F} - {n}_{C}}$$

Advantageously, the polyesters according to the invention have a high impact strength. Preferably, the impact strength of the polyester according to the invention, measured at room temperature, is greater than 100 kJ/m² for an unnotched test specimen and greater than 5 kJ/m² for a notched test specimen. It may be evaluated by means of a Charpy impact test according to standard ISO 179 (unnotched: ISO 179 1eU, notched: ISO 179 1eA).

The unit (A) is a 1,4:3,6-dianhydrohexitol unit. As explained previously, 1,4:3,6-dianhydrohexitols have the drawback of being secondary diols which are not very reactive in the production of polyesters. The 1,4:3,6-dianhydrohexitol (A) may be isosorbide, isomannide, isoidide, or a mixture thereof. Preferably, the 1,4:3,6-dianhydrohexitol (A) is isosorbide.

Isosorbide, isomannide and isoidide may be obtained, respectively, by dehydration of sorbitol, of mannitol and of iditol. As regards isosorbide, it is sold by the Applicant under the brand name Polysorb® P.

The polyester according to the invention preferably has at least 1%, preferably at least 2%, more preferentially at least 5%, and more preferentially still at least 10% of 1,4:3,6-dianhydrohexitol units (A) relative to all the diol units present in the polyester.

The amount of 1,4:3,6-dianhydrohexitol units (A) in the polyester may be determined by 1H NMR or by chromatographic analysis of the mixture of monomers resulting from complete hydrolysis or methanolysis of the polyester, preferably by 1H NMR.

Those skilled in the art can easily find the analysis conditions for determining the amount of 1,4:3,6-dianhydrohexitol units (A) of the polyester. For example, from an NMR spectrum of a poly(spiroglycol-co-isosorbide terephthalate), the chemical shifts relating to the spiroglycol are between 0.7 and 0.9 ppm, 3.1 and 3.6 ppm and between 4.1 and 4.3 ppm, and the chemical shifts relating to the isosorbide are between 4.1 and 5.8 ppm. The integration of each signal makes it possible to determine the relative amount of a unit relative to all of the two diol units.

The cyclic diol (B) may be selected from spiroglycol, tricyclo[5.2.1.02,6]decanedimethanol (TCDDM), 2,2,4,4-tetramethyl-1,3-cyclobutanediol, tetrahydrofurandimethanol (THFDM), furandimethanol, 1,2-cyclopentanediol, 1,3-cyclopentanediol, 1,2-cyclohexanediol, 1,4-cyclohexanediol, 1,2-cycloheptanediol, 1,5-naphthalenediol, 2,7-naphthalenediol, 1,4-naphthalenediol, 2,3-naphthalenediol, 2-methyl-1,4-naphthalenediol, 1,4,-benzenediol, octahydronaphthalene-4,8-diol, dioxane glycol (DOG), norbornanediols, adamanthanediols, and pentacyclopentadecanedimethanols.

In a preferred embodiment, the cyclic diol (B) is spiroglycol, tricyclo[5.2.1.02,6]decanedimethanol (TCDDM) or a mixture of these two diols.

Advantageously, the polyester according to the invention is devoid of cyclohexanedimethanol units.

The aromatic dicarboxylic acid unit (C) is advantageously selected from terephthalic acid, 2,5-furandicarboxylic acid, 2,6-naphthalenedicarboxylic acid or isophthalic acid units and mixtures of two or more of these acid units.

According to one embodiment, the polyester according to the invention only contains one type of aromatic dicarboxylic acid unit. In other words, according to this embodiment, the polyester of the invention advantageously contains at least one terephthalic acid unit, at least one 2,5-furandicarboxylic acid unit or at least one 2,6-naphthalenedicarboxylic acid unit or at least one isophthalic acid unit.

Advantageously, the polyester according to the invention has a reduced viscosity in solution of greater than 40 ml/g, preferably greater than 45 ml/g, and more preferentially greater than 50 ml/g. The reduced viscosity in solution is evaluated using an Ubbelohde capillary viscometer at 35° C. The polymer is dissolved beforehand in ortho-chlorophenol at 130° C. with magnetic stirring. For these measurements, the polymer concentration introduced is 5 g/l.

The polyester of the invention may for example comprise:
a molar amount of 1,4:3,6-dianhydrohexitol units (A) ranging from 5 to 45%;
a molar amount of cyclic diol units (B) other than cyclohexanedimethanol units and the 1,4:3,6-dianhydrohexitol units (A) ranging from 3 to 47%;
a molar amount of dicarboxylic acid units (C) ranging from 48 to 52%.

The amounts of different units in the polyester may be determined by ¹H NMR or by chromatographic analysis of the mixture of monomers resulting from complete hydrolysis or methanolysis of the polyester, preferably by ¹H NMR.

Those skilled in the art can easily find the analysis conditions for determining the amounts of each of the units of the polyester. For example, from an NMR spectrum of a poly(spiroglycol-co-isosorbide terephthalate), the chemical shifts relating to the spiroglycol are between 0.7 and 0.9 ppm, between 3.1 and 3.6 ppm and between 4.1 and 4.3 ppm, the chemical shifts relating to the terephthalate ring are between 7.8 and 8.4 ppm and the chemical shifts relating to the isosorbide are between 4.1 and 5.8 ppm. The integration of each signal makes it possible to determine the amount of each unit of the polyester.

The polyester according to the invention may be semi-crystalline or amorphous.

When the polyester according to the invention is semi-crystalline, it advantageously has a crystallization temperature ranging from 175 to 250° C., preferably from 190 to 220° C. for example from 195 to 215° C.

Preferably, when the polyester according to the invention is semi-crystalline, it has a melting point ranging from 210 to 320° C., for example from 225 to 310° C.

The crystallization temperatures and melting points are measured by conventional methods, especially using differential scanning calorimetry (DSC) using a heating rate of 10° C./min. The experimental protocol is described in detail in the example section below.

Another subject of the invention is a process for producing the polyester according to the invention. This process comprises:
a step of introducing, into a reactor, monomers comprising at least one 1,4:3,6-dianhydrohexitol (A), at least one alicyclic diol (B) other than the 1,4:3,6-dianhydrohexitols (A) and at least one dicarboxylic acid (C), said monomers being devoid of ethylene glycol;
a step of introducing, into the reactor, a catalytic system;
a step of polymerizing said monomers to form the polyester, said step consisting of:
   a first stage of oligomerization, during which the reaction medium is firstly stirred under inert atmosphere at a temperature ranging from 150 to 250° C., advantageously from 170 to 240° C., more advantageously from 180 to 235° C., then brought to a temperature ranging from 230 to 300° C., advantageously ranging from 240 to 290° C., more advantageously from 245 to 270° C.;
   a second stage of condensation of the oligomers, during which the oligomers formed are stirred under vacuum at a temperature ranging from 240 to 320° C. so as to form the polyester, advantageously from 275 to 310° C., more advantageously from 289 to 310° C.;
a step of recovering the polyester.

If the polyester according to the invention is semi-crystalline, this process may comprise a step of solid-state post-condensation under vacuum or while flushing with an inert gas, such as nitrogen (N₂) for example, and at a temperature lower by 5 to 30° C. than the melting point of the polyester.

Catalytic system is intended to mean a catalyst or a mixture of catalysts, optionally dispersed or fixed on an inert support.

The catalytic system is advantageously selected from the group consisting of tin derivatives, preferentially derivatives of tin, titanium, zirconium, germanium, antimony, bismuth, hafnium, magnesium, cerium, zinc, cobalt, iron, manganese, calcium, strontium, sodium, potassium, aluminum or lithium, or of a mixture of two or more of these catalysts.

Examples of such compounds may for example be those given in patent EP 1 882 712 B1 in paragraphs [0090] to [0094].

The catalyst is preferably a derivative of tin, titanium, germanium, aluminum or antimony, more preferentially a derivative of tin or a derivative of germanium, for example dibutyltin dioxide or germanium oxide.

The catalytic system is used in catalytic amounts customarily used for the production of aromatic polyesters. By way of example of amounts by weight, use may be made of from 10 to 500 ppm of catalytic system during the stage of condensation of the oligomers, relative to the amount of monomers introduced.

According to the process of the invention, an antioxidant is advantageously used during the step of polymerization of the monomers. These antioxidants make it possible to reduce the coloration of the polyester obtained. The antioxidants may be primary and/or secondary antioxidants. The primary antioxidant may be a sterically hindered phenol, such as the compounds Hostanox® 0 3, Hostanox® 0 10, Hostanox® 0 16, Ultranox® 210, Ultranox® 276, Dovernox® 10, Dovernox® 76, Dovernox® 3114, Irganox® 1010 or Irganox® 1076 or a phosphonate such as Irgamod® 195. The secondary antioxidant may be trivalent phosphorus compounds such as Ultranox® 626, Doverphos® S-9228, Hostanox® P-EPQ or Irgafos 168.

It is also possible to introduce as polymerization additive into the reactor at least one compound that is capable of limiting unwanted etherification reactions, such as sodium acetate, tetramethylammonium hydroxide or tetraethylammonium hydroxide.

The process of the invention comprises a step of recovering the polyester resulting from the polymerization step. The polyester can be recovered by extracting it from the reactor in the form of a molten polymer rod. This rod can be transformed into granules using conventional granulation techniques.

Another subject of the invention is a polyester that can be obtained by the process of the invention.

The invention also relates to a composition comprising the polyester according to the invention, this composition possibly also comprising at least one additive or at least one additional polymer or at least one mixture thereof.

The polyester composition according to the invention may comprise the polymerization additives optionally used during the process. It may also comprise other additives and/or additional polymers that are generally added during a subsequent thermomechanical mixing step.

By way of examples of additives, mention may be made of fillers or fibers of organic or mineral, nanometric or non-nanometric, functionalized or non-functionalized nature. They may be silicas, zeolites, glass fibers or beads, clays, mica, titanates, silicates, graphite, calcium carbonate, carbon nanotubes, wood fibers, carbon fibers, polymer fibers, proteins, cellulose-based fibers, lignocellulosic fibers and non-destructured granular starch. These fillers or fibers can make it possible to improve the hardness, the rigidity or the water- or gas-permeability. The composition may comprise from 0.1% to 75% by weight of fillers and/or fibers relative to the total weight of the composition, for example from 0.5% to 50%. The additive that is of use in the composition according to the invention may also comprise opacifiers, dyes and pigments. They may be chosen from cobalt acetate and the following compounds: HS-325 Sandoplast® Red BB (which is a compound bearing an azo function, also known under the name Solvent Red 195), HS-510 Sandoplast® Blue 2B which is an anthraquinone, Polysynthren® Blue R, and Clariant® RSB Violet.

The composition may also comprise, as additive, a processing aid, for reducing the pressure in the processing tool. A demolding aid which makes it possible to reduce the adhesion to the materials for forming the polyester, such as the molds or the calendering rollers, may also be used. These aids may be selected from fatty acid esters and fatty acid amides, metal salts, soaps, paraffins and hydrocarbon-based waxes. Particular examples of these aids are zinc stearate, calcium stearate, aluminum stearate, stearamides, erucamides, behenamides, beeswaxes or candelilla wax.

The composition according to the invention may also comprise other additives, such as stabilizers, for example light stabilizers, UV stabilizers and heat stabilizers, fluidizers, flame retardants and antistatic agents.

The composition may also comprise an additional polymer other than the polyester according to the invention. This polymer may be chosen from polyamides, polyesters other than the polyester according to the invention, polystyrene, styrene copolymers, styrene-acrylonitrile copolymers, styrene-acrylonitrile-butadiene copolymers, poly(methyl methacrylate)s, acrylic copolymers, poly(ether-imide)s, poly(phenylene oxide)s, such as poly(2,6-dimethylphenylene oxide), poly(phenylene sulfate)s, poly(ester-carbonate)s, polycarbonates, polysulfones, polysulfone ethers, polyether ketones, and mixtures of these polymers.

The composition may also comprise, as additional polymer, a polymer which makes it possible to improve the impact properties of the polymer, especially functional polyolefins such as functionalized ethylene or propylene polymers and copolymers, core-shell copolymers or block copolymers.

The composition according to the invention may also comprise polymers of natural origin, such as starch, cellulose, chitosans, alginates, proteins such as gluten, pea proteins, casein, collagen, gelatin or lignin, these polymers of natural origin possibly being physically or chemically modified. The starch may be used in destructured or plasticized form. In the latter case, the plasticizer may be water or a polyol, especially glycerol, polyglycerol, isosorbide, sorbitans, sorbitol, mannitol or else urea. The process described in document WO 2010/010 282 A1 may especially be used to prepare the composition.

The composition according to the invention may be produced by conventional thermoplastics mixing methods. These conventional methods comprise at least one step of mixing the polymers in the molten or softened state and a step of recovering the composition. This process may be performed in paddle or rotor internal mixers, external mixers, or single-screw or twin-screw co-rotating or counter-rotating extruders. However, it is preferred to produce this mixture by extrusion, especially using a co-rotating extruder.

The mixing of the constituents of the composition may take place under an inert atmosphere.

In the case of an extruder, the various constituents of the composition may be introduced by means of feed hoppers located along the extruder.

The invention also relates to the use of the polyester or of the composition in the field of optical articles, especially for the manufacture of optical lenses or optical films. It may also be used for the manufacture of multilayer articles.

The invention also relates to a plastic, finished or semi-finished article comprising the polyester or the composition according to the invention.

This article may be of any type and may be obtained using conventional transformation techniques.

It may for example be an optical article, i.e. an article requiring good optical properties, such as lenses, disks, transparent or translucent panels, light-emitting diode (LED) components, optical fibers, films for LCD screens or else windows. By virtue of the high glass transition temperature of the polyester according to the invention, the optical articles have the advantage of being able to be placed close to sources of light and therefore of heat, while retaining excellent dimensional stability and good resistance to light.

The article according to the invention may also be a multilayer article, at least one layer of which comprises the polymer or the composition according to the invention. These articles may be manufactured via a process comprising a coextrusion step in the case where the materials of the various layers are placed in contact in the molten state. By way of example, mention may be made of the techniques of tube coextrusion, profile coextrusion, coextrusion blow-molding of a bottle, a small bottle or a tank, generally collated under the term “coextrusion blow-molding of hollow bodies”, coextrusion blow-molding also known as film blowing, and cast coextrusion.

They may also be manufactured according to a process comprising a step of applying a layer of molten polyester onto a layer based on organic polymer, metal or adhesive composition in the solid state. This step may be performed by pressing, by overmolding, stratification or lamination, extrusion-lamination, coating, extrusion-coating or spreading.

The article according to the invention may also be a fiber, a thread or a filament. The filaments may be obtained by various processes such as wet spinning, dry spinning, melt spinning, gel spinning (or dry-wet spinning), or else electrospinning. The filaments obtained by spinning may also be stretched or oriented.

The filaments, if desired, may be cut into short fibers; this makes it possible to mix these fibers with other fibers to create mixtures and obtain a thread.

The threads or filaments may also be woven, for the manufacture of fabrics for the clothing industry, carpets, curtains, wall hangings, household linens, wall coverings, boat sails, furniture fabrics or else safety belts or straps.

The threads, fibers or filaments may also be used in technical applications as reinforcers, such as in pipes, power belts, tires, or as a reinforcer in any other polymer matrix.

The threads, fibers or filaments may also be assembled in the form of nonwovens (e.g. felts), in the form of ropes, or else knitted in the form of nets.

The invention will now be illustrated in the examples below. It is specified that these examples do not in any way limit the present invention.

### EXAMPLES

The properties of the polymers were studied via the following techniques:

The thermal properties of the polyesters were measured by differential scanning calorimetry (DSC): the sample is first heated under a nitrogen atmosphere in an open crucible from 10° C. to 320° C. (10° C.min⁻¹), cooled to 10° C. (10° C.min⁻¹), then heated again to 320° C. under the same conditions as the first step. The glass transition temperatures were taken at the mid-point of the second heating. Any crystallization temperatures are determined on the exothermic peak (onset) at cooling. Any melting points are determined on the endothermic peak (onset) at the second heating. Similarly, the enthalpy of fusion (area under the curve) is determined at the second heating.

The reduced viscosity in solution is evaluated using an Ubbelohde capillary viscometer at 35° C. The polymer is dissolved beforehand in ortho-chlorophenol at 130° C. with magnetic stirring. For these measurements, the polymer concentration introduced is 5 g/l. The content of isosorbide of the final polyester was determined by ¹H NMR by integrating the signals relating to each unit of the polyester.

For the illustrative examples presented below, the following reagents were used:
Ethylene glycol (purity >99.8%) from Sigma-Aldrich
Spiroglycol (purity >97%) from TCI
Tricyclo[5.2.1.02,6]decanedimethanol (TCDDM, purity 96%) from Sigma-Aldrich
Isosorbide (purity >99.5%) Polysorb® P from Roquette Freres
Terephthalic acid (99+% purity) from Acros
2,5-Furandicarboxylic acid (purity 99.7%) from Satachem
Isophthalic acid (purity 99%) from Sigma-Aldrich
2,6-Naphthalenedicarboxylic acid (purity 99.8%) from BASF
Germanium dioxide (>99.99%) from Sigma-Aldrich
Dibutyltin dioxide (purity 98%) from Sigma-Aldrich

### Preparation of the Polyesters

### Example 1

25 g of dimethyl terephthalate, 2.4 g of isosorbide, 67.5 g of spiroglycol and 20 mg of dibutyltin dioxide are introduced into a reactor. The mixture is stirred by mechanical stirring at 150 rpm and is heated to 190° C. over the course of 15 min under a nitrogen stream. Still under a nitrogen stream and mechanical stirring, the reaction medium is then maintained at 190° C. for 5 minutes, before being again heated to 265° C. over the course of 10 minutes. This temperature is maintained for 3 h.

Following this, the temperature is increased to 300° C., the pressure is reduced over the course of 1 hour to 0.7 mbar and the stirring speed is reduced to 50 rpm. These conditions will be maintained for 3 h.

The polymer obtained is a semi-crystalline material, the glass transition temperature of which is 130° C., having a crystallization temperature of 200° C., a melting point of 281° C. and a reduced viscosity of 63.8 ml/g (concentration at 5 g/l in 2-chlorophenol at 35° C.). The analysis of the final polyester by NMR shows that 5% of isosorbide (relative to diols) has been introduced into the polymer chains.

### Example 1a

The polyester from Example 1 is used in a solid-state post-condensation step. First, the polymer is crystallized for 2 h in an oven under vacuum at 190° C. The crystallized polymer is then introduced into an oil bath rotavap fitted with a cannulated flask. The granules are then subjected to a temperature of 270° C. and a nitrogen flow of 3.3 l/min. After 25 h of post-condensation, the polymer will have a reduced viscosity in solution of 105.8 ml/g.

### Example 2

25 g of dimethyl terephthalate, 10.5 g of isosorbide, 50.8 g of spiroglycol and 20 mg of dibutyltin dioxide are introduced into a reactor. The mixture is stirred by mechanical stirring at 150 rpm and is heated to 190° C. over the course of 15 min under a nitrogen stream. Still under a nitrogen stream and mechanical stirring, the reaction medium is then maintained at 190° C. for 5 minutes, before being again heated to 265° C. over the course of 10 minutes. This temperature is maintained for 4 h.

Following this, the temperature is increased to 300° C., the pressure is reduced over the course of 1 hour to 0.7 mbar and the stirring speed is reduced to 50 rpm. These conditions will be maintained for 4 h.

The polymer obtained is an amorphous material, the glass transition temperature of which is 149° C., and the reduced viscosity of which is 54.9 ml/g (concentration at 5 g/l in 2-chlorophenol at 35° C.). The analysis of the final polyester by NMR shows that 27% of isosorbide (relative to diols) has been introduced into the polymer chains.

### Example 3

25 g of 2,6-naphthalene dicarboxylic acid, 4.0 g of isosorbide, 33.3 g of spiroglycol and 20 mg of dibutyltin dioxide are introduced into a reactor. The mixture is stirred by mechanical stirring at 150 rpm and is heated to 230° C. over the course of 15 min under a nitrogen stream. Still under a nitrogen stream and mechanical stirring, the reaction medium is then maintained at 230° C. for 5 minutes, before being again heated to 265° C. over the course of 10 minutes. This temperature is maintained for 4 h.

Following this, the temperature is increased to 310° C., the pressure is reduced over the course of 1 hour to 0.7 mbar and the stirring speed is reduced to 50 rpm. These conditions will be maintained for 4 h.

The polymer obtained is a semi-crystalline material, the glass transition temperature of which is 169° C., having a crystallization temperature of 210° C., a melting point of 292° C. and a reduced viscosity of 49.4 ml/g (concentration at 5 g/l in 2-chlorophenol at 35° C.). The analysis of the final polyester by NMR shows that 17% of isosorbide (relative to diols) has been introduced into the polymer chains.

### Example 3a

The polyester from Example 3 is used in a solid-state post-condensation step. First, the polymer is crystallized for 2 h in an oven under vacuum at 190° C. The crystallized polymer is then introduced into an oil bath rotavap fitted with a cannulated flask. The granules are then subjected to a temperature of 270° C. and a nitrogen flow of 3.3 l/min. After 28 h of post-condensation, the polymer will have a reduced viscosity in solution of 78.2 ml/g.

### Example 4

25 g of dimethyl terephthalate, 42.2 g of 4,8-tricyclo[5.2.1.02,6]decanedimethanol (mixture of isomers), 4.2 g of isosorbide and 17.9 mg of dibutyltin oxide are introduced into a reactor. The mixture is stirred by mechanical stirring at 150 rpm and is heated to 190° C. over the course of 10 min under a nitrogen stream. Still under a nitrogen stream and mechanical stirring, the reaction medium is then maintained at 190° C. for 5 minutes, before being again heated to 250° C. over the course of 20 minutes. This temperature is maintained for 120 minutes.

Following this, the temperature is increased to 280° C., the pressure is reduced over the course of 30 min to 0.7 mbar and the stirring speed is reduced to 50 rpm. These conditions will be maintained for 3 h.

The polymer obtained is an amorphous material, the glass transition temperature of which is 119° C., and the reduced viscosity of which is 58.4 ml/g (concentration at 5 g/l in 2-chlorophenol at 35° C.). The analysis of the final polyester by NMR shows that 11% of isosorbide (relative to diols) has been introduced into the polymer chains.

### Example 5

25 g of dimethyl terephthalate, 33.5 g of 4,8-tricyclo[5.2.1.02,6]decanedimethanol (mixture of isomers), 10.7 g of isosorbide and 17.9 mg of dibutyltin oxide are introduced into a reactor. The mixture is stirred by mechanical stirring at 150 rpm and is heated to 190° C. over the course of 10 min under a nitrogen stream. Still under a nitrogen stream and mechanical stirring, the reaction medium is then maintained at 190° C. for 5 minutes, before being again heated to 250° C. over the course of 20 minutes. This temperature is maintained for 180 minutes.

Following this, the temperature is increased to 280° C., the pressure is reduced over the course of 30 min to 0.7 mbar and the stirring speed is reduced to 50 rpm. These conditions will be maintained for 4 h 30.

The polymer obtained is an amorphous material, the glass transition temperature of which is 135° C., and the reduced viscosity of which is 51.3 ml/g (concentration at 5 g/l in 2-chlorophenol at 35° C.). The analysis of the final polyester by NMR shows that 27% of isosorbide (relative to diols) has been introduced into the polymer chains.

1. A thermoplastic polyester comprising:
at least one 1,4:3,6-dianhydrohexitol unit (A);
at least one cyclic diol unit (B) other than cyclohexanedimethanol units and the 1,4:3,6-dianhydrohexitol units (A);
at least one aromatic dicarboxylic acid unit (C);
said polyester being devoid of ethylene glycol units.

2. The polyester as claimed in claim 1, having a glass transition temperature of at least 95° C.

3. The polyester as claimed in claim 1, wherein the 1,4:3,6-dianhydrohexitol (A) is isosorbide.

4. The polyester as claimed claim 1, wherein the cyclic diol (B) is selected from spiroglycol, tricyclo[5.2.1.02,6]decanedimethanol (TCDDM), 2,2,4,4-tetramethyl-1,3-cyclobutanediol, tetrahydrofurandimethanol (THFDM), furan-dimethanol, 1,2-cyclopentanediol, 1,3-cyclopentanediol, 1,2-cyclohexanediol, 1,4-cyclohexanediol, 1,2-cycloheptanediol, 1,5-naphthalenediol, 2,7-naphthalenediol, 1,4-naphthalenediol, 2,3-naphthalenediol, 2-methyl-1,4-naphthalenediol, 1,4,-benzenediol, octahydronaphthalene-4,8-diol, dioxane glycol (DOG), norbornanediols, adamanthanediols, and pentacyclopentadecanedimethanols.

5. The polyester as claimed in claim 1, wherein it is devoid of cyclohexanedimethanol units.

6. The polyester as claimed in claim 1, wherein the polyester comprises:
a molar amount of 1,4:3,6-dianhydrohexitol units (A) ranging from 5 to 45%;
a molar amount of cyclic diol units (B) other than cyclohexanedimethanol units and the 1,4:3,6-dianhydrohexitol units (A) ranging from 3 to 47%;
a molar amount of dicarboxylic acid units (C) ranging from 48 to 52%.

7. The polyester as claimed claim 1, wherein it is amorphous.

8. The polyester as claimed claim 1, wherein it is semi-crystalline.

9. A process for producing the polyester as claimed claim 1, said process comprising:
a step of introducing, into a reactor, monomers comprising at least one 1,4:3,6-dianhydrohexitol (A), at least one alicyclic diol (B) other than the 1,4:3,6-dianhydrohexitols (A) and at least one dicarboxylic acid (C), said monomers being devoid of ethylene glycol;
a step of introducing, into the reactor, a catalytic system;
a step of polymerizing said monomers to form the polyester, said step consisting of:
a first stage of oligomerization, during which the reaction medium is firstly stirred under inert atmosphere at a temperature ranging from 150 to 250° C., then brought to a temperature ranging from 230 to 300° C.;
a second stage of condensation of the oligomers, during which the oligomers formed are stirred under vacuum at a temperature ranging from 240 to 320° C. so as to form the polyester; and
a step of recovering the polyester.

10. The process as claimed in claim 9, wherein the polyester is semi-crystalline and the process comprises a step of solid-state post-condensation under vacuum or while flushing with an inert gas and at a temperature lower by 5 to 30° C. than the melting point of the polyester.

11. A polyester able to be obtained by the process as claimed in claim 9.

12. A polyester composition comprising a polyester as claimed in claim 1.

13. A method comprising applying, in the field of optical articles or multilayer plastic articles, the polyester as claimed in claim 1.

14. A plastic article comprising a polyester as claimed in claim 1.
